(19) United States
(12) Patent Application Publication
(10) Pub. No.: US 2023/0274239 A1
(43) Pub. Date: Aug. 31, 2023

(54) TRACEABLE TRANSPORT OF RESIDUAL MATERIAL

(71) Applicant: TRUMPF Schweiz AG, Gruesch (CH)

(72) Inventor: Tobias Meck, Igis (CH)

(21) Appl. No.: 18/314,154

(22) Filed: May 9, 2023

Related U.S. Application Data
(63) Continuation of application No. PCT/EP2021/081090, filed on Nov. 9, 2021.

(30) Foreign Application Priority Data
Nov. 10, 2020 (DE) 10 2020 214 133.9

(51) Int. Cl. G06Q 10/30; G06Q 10/0833

(52) U.S. Cl. CPC G06Q 10/30; G06Q 10/0833

(57) ABSTRACT

A method recycles residual material. The method includes: C) filling unmixed residual material into a container having a tracker of a track and trace system; D) storing information about a type of material of the unmixed residual material in the tracker; and E) transporting the container to a recycler of the unmixed residual material. The method steps C) and D) are performable in any order or at the same time.

### CROSS REFERENCE TO RELATED APPLICATIONS

This application is a continuation of International Application No. PCT/EP2021/081090 (WO 2022/101189 A1), filed on Nov. 9, 2021, and claims benefit to German Patent Application No. DE 10 2020 214 133.9 A1, filed on Nov. 10, 2020. The aforementioned applications are hereby incorporated by reference herein

### FIELD

The present disclosure relates to a method and to a system for recycling residual material.

### BACKGROUND

Residual material that accrues in a manufacturing process can be recycled. In particular in sheet-metal processing, skeletons that accrue when cutting sheet-metal parts out of sheet-metal plates can be recycled by being melted down again in the steel plant.

The transport of the residual material may be traced using a database. This has been disclosed, for example, in US 2009/0201369 A1 and WO 2018/099549 A1. However, the present inventors have recognized the fact that the accrued residual material is not processed in unmixed form, but rather for example is mixed with household scrap, is a problem. The energy expenditure used by the recycler of the residual material is thereby unnecessarily increased.

### SUMMARY

In an embodiment, the present disclosure provides a method that recycles residual material. The method includes: C) filling unmixed residual material into a container having a tracker of a track and trace system; D) storing information about a type of material of the unmixed residual material in the tracker; and E) transporting the container to a recycler of the unmixed residual material. The method steps C) and D) are performable in any order or at the same time.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a system and method implemented according to aspects of the present disclosure.

### DETAILED DESCRIPTION

Aspects of the present disclosure provide a method and a system enabling energy-efficient recycling of residual material.

Accordingly, an aspect of the present disclosure provides a method for recycling residual material, the method comprising at least the following method steps:
C) filling, in particular, unmixed residual material into a container, wherein the container has a tracker of a track and trace system;
D) storing information about the type of material of the residual material in the tracker;
wherein method steps C) and D) may be performed in any desired order or at the same time;
E) transporting the container to a recycler of the residual material.

The method implemented according to aspects of the present disclosure thus makes it possible to track, in particular, unmixed, preferably predominantly unmixed, residual material as far as the recycler of the residual material. The recycler is then able to prepare the residual material, and make it available again with low energy expenditure. Mixing, for example of unmixed scrap with household scrap, is able to be largely avoided. This saves energy and protects the environment, and the supplier of the preferably largely unmixed material may expect a higher price for the supplied residual material.

It should be noted here that “recycling” should not necessarily be understood to mean the entire material cycle, but also part of the material cycle.

It should also be noted that, in method step D), further information, in addition to the type of material, may also be stored in the tracker.

A recycler may be understood to mean, in particular, a scrap merchant and/or a steel plant.

A tracker of a track and trace system is in this case understood to mean a tag that is able to be detected by a positioning system, in particular a GPS and/or an indoor positioning system. The tracker may be located using one or more scanners, on which the tracker may be logged in. The tracker may preferably be located using anchors by performing a time-of-flight measurement of signals between the tracker and the anchors and then determining the position of the tracker by way of triangulation. The track and trace system is designed to trace the position of the tracker, and thus, implicitly the position of the residual material in the container.

According to an aspect of the present disclosure, the following method step is preferably performed prior to method step C):

B) crushing the residual material using a crusher and storing the information about the type of material of the residual material on the tracker in method step D) using the crusher.

The residual material is able to be stored in the container in a space-saving manner due to the crusher. Because higher prices are typically paid by the recycler for unmixed residual material, the costs of a crusher are quickly amortized.

Aspects of the present disclosure are able to be implemented particularly effectively in sheet-metal processing. In this case, the residual material may be present in the form of a skeleton remaining from a sheet-metal plate. The skeleton may in this case be crushed by a crusher in the form of skeleton clippers.

According to an aspect of the present disclosure, the following method step may be performed prior to method step B):

A) cutting sheet-metal parts out of a sheet-metal plate using a machine tool, so as to produce the skeleton.

The machine tool is preferably designed in the form of a cutting machine for cutting sheet-metal parts out of a sheet-metal plate. The machine tool may in particular be designed in the form of a laser cutting machine and/or a punching machine.

The information about the residual material may be transmitted from the machine tool to the crusher in a wireless and/or wired manner.

The information about the type of material may be transmitted from the machine tool to the skeleton clippers via a data connection, in which the machine tool and the skeleton clippers are each connected to the Internet and/or an Intranet via a network connection.

As an alternative or in addition thereto, the information about the residual material may be applied to the skeleton in the form of a code at the machine tool and be read by a camera of the skeleton clippers. The code may be present in the form of a dot-matrix code.

The information about the residual material may particularly preferably be stored in the material table of the machine tool. The information is thereby available without extra effort.

The residual material is particularly easy to process for the recycler when the tracker contains information about the material number, the producer and/or the weight of the residual material.

In method step D), the comment “ready for collection” may be stored on the tracker when for the time being no further residual material of this sort is accrued and/or the container is full.

The fill level of the container may be ascertained using a scales.

The tracker may output or initiate a warning if mixing of different residual materials, in particular when filling the container of the crusher into a collecting container, takes place or is intended to take place.

The information stored on the tracker may be uploaded at least partially, in particular completely, to a cloud-based server. As an alternative or in addition thereto, position information of the tracker may be uploaded to the cloud-based server in order to be able to easily trace the position of the tracker.

In one particularly preferred embodiment implemented according to aspects of the present disclosure, the information stored on the tracker is displayed at least partially, in particular completely, in an online marketplace. The in particular unmixed residual material may thereby be offered simultaneously to various recyclers.

Aspects of the present disclosure further provide a system having at least the following features:
a) a container and a track and trace system, wherein a tracker of the track and trace system is arranged or formed on the container, wherein at least information about the type of material of residual material stored in the container is able to be stored on the tracker;
b) a crusher, in particular in the form of skeleton clippers, for filling the container with in particular unmixed residual material.

The system preferably has a machine tool for feeding the crusher, in particular in the form of the skeleton clippers.

The crusher is particularly preferably designed to store information about the residual material on the tracker.

The machine tool may be connected to the crusher in a wireless and/or wired manner in order to transmit the information about the residual material from the machine tool to the crusher.

As an alternative or in addition thereto, the crusher may have a camera in order to scan a code on the residual material, in particular on the skeleton, and to read the information about the residual material therefrom.

The code may be present in the form of a dot-matrix code.

The machine tool and the crusher may each have a network connection in order to transmit the information about the residual material from the machine tool to the crusher.

The system may have a scales for ascertaining the fill level of the container, wherein the fill level is able to be stored on the tracker.

The system may have a cloud-based server to which the information about the residual material is able to be transmitted. To this end, the cloud-based server may be connected to the crusher, to the machine tool and/or to the tracker in a wireless and/or wired manner.

The system may furthermore have an online marketplace in which the information about the residual material is able to be displayed.

Further advantages of the present disclosure are evident from the description and the drawing. Similarly, according to the present disclosure, the features mentioned above and those still to be further presented may be used in each case individually or together in any desired combinations. The embodiments shown and described should not be understood as an exhaustive enumeration, but rather are of an exemplary character for outlining aspects of the present disclosure.

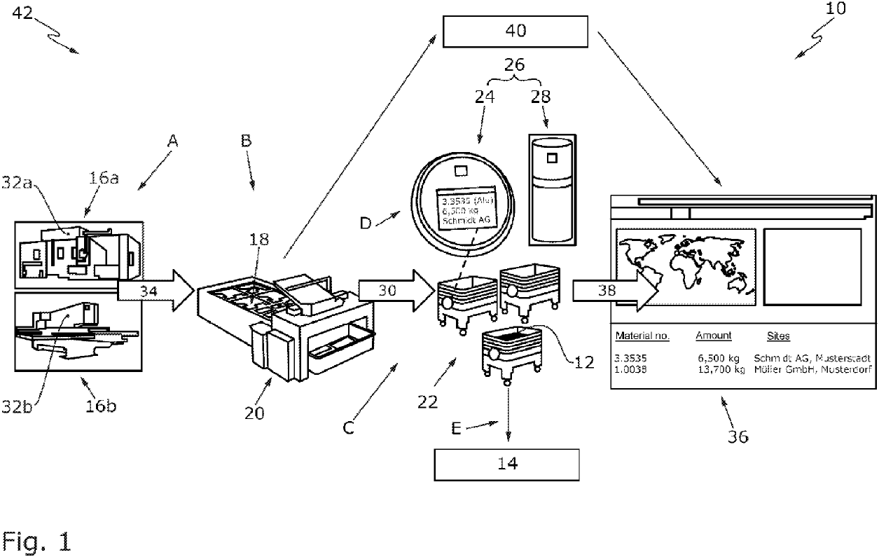

FIG. 1 shows a system 10 for recycling residual material 12. The residual material 12 typically accrues as waste in a manufacturing process. The residual material 12 may be present as sheet-metal waste. The residual material 12 is transported to a recycler 14. In the case of sheet-metal waste, the recycler 14 is typically a steel plant in which the residual material 12 is melted down. Since the residual material 12 is often not delivered to the recycler 14 in unmixed form and/or without more detailed material information, preparing the residual material 12 requires a great deal of energy expenditure. Aspects of the present disclosure, by contrast, make it possible to prepare the residual material 12 with considerably less energy expenditure.

Aspects of the present disclosure are described below for the case whereby the residual material 12 is present in the form of sheet-metal waste from a sheet-metal part manufacturing process.

To manufacture sheet-metal parts, provision is made for at least one machine tool 16a, 16a. The machine tool 16a, b may be designed in the form of a cutting machine. In the present case, the machine tool 16a is a laser cutting machine and the machine tool 16b is a punching machine.

Skeletons 18 accrue when manufacturing the sheet-metal parts from a sheet-metal plate. The skeletons 18 may be crushed in a crusher 20, here in the form of skeleton clippers 20. The crushed residual material 12 is filled into a container 22 in order to be transported to the recycler 14.

According to an aspect of the present disclosure, provision is now made to fill the container 22 with in particular unmixed residual material 12, that is to say of a single type of material, and to link the information about this residual material to the container 22.

A tracker 24, which is arranged or formed on the container 22, is used for this purpose. The tracker 24 may in this case contain information about the type of material, the amount or the weight of the residual material 12 and/or the producer of the residual material 12.

The tracker 24 is part of a track and trace system 26. The track and trace system 26 may in this case have at least one scanner 28 and/or be part of an indoor localization system. The indoor localization system may in this case have multiple anchors in order to determine the position of the tracker 24. The tracker 24 may also be referred to as tag of the indoor localization system.

The tracker 24 is able to obtain the information about the residual material 12 from the crusher 20 in a wireless and/or wired manner. This is illustrated schematically in FIG. 1 by a data arrow 30. The crusher 20 is in turn able to obtain the information about the residual material 12 from a machine tool 16a, b in a wireless and/or wired manner. The information about the residual material 12 may in particular be stored in a material table 32a, 32b of a machine tool 16a, 16b. The transmission of the information to the crusher 20 is illustrated schematically in FIG. 1 by a data arrow 34.

The container 22 may be sent to a predetermined recycler 14. As an alternative thereto, the system 10 may comprise an online marketplace 36 in which the residual material 12 is offered and/or traded. The transmission of the information about the residual material 12 to the online marketplace 36 is illustrated schematically in FIG. 1 by a data arrow 38.

The online marketplace 36 is able to obtain the information about the residual material 12 from a cloud-based server 40. The cloud-based server 40 is able to obtain this information from a machine tool 16a, b, the crusher 20 and/or the tracker 24.

The system 10 thus makes it possible to deliver in particular unmixed residual material 12 to the recycler 14 with the associated material information. This is also apparent in FIG. 1 in the form of a method 42 (here in the case of sheet-metal processing) comprising the following method steps:
A) cutting out sheet-metal parts and producing residual material 12 in the form of a skeleton 18;
B) crushing the skeleton 18 in the crusher 20;
C) filling the residual material 12 into the container 22, wherein the container 22 is provided with a tracker 24;
D) storing information about the residual material 12 in the tracker 24;
E) transporting the residual material 12 to the recycler 14.

Prior to method step E), the residual material may be traded in the online marketplace 36.

Considering the drawing, the present disclosure thus relates collectively to a system 10 and to a method 42 for the in particular unmixed and identified delivery of residual material 12 to a recycler 14. Information about the residual material 12, in particular about the type of material of the residual material 12, is in this case stored on a tracker 24 on the container 22 of the residual material 12. The tracker 24 is able to obtain the information from a crusher 20, which is in turn able to obtain the information from a machine tool 16a, b, in particular from a material table 32a, b of the machine tool 16a, b. The information may furthermore be used to offer the residual material 12 in an online marketplace 36.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

LIST OF REFERENCE SIGNS

| | |
|---|---|
| 10 | System |
| 12 | Residual material |
| 14 | Recycler |
| 16a, b | Machine tool |
| 18 | Skeleton |
| 20 | Crusher |
| 22 | Container |
| 24 | Tracker |
| 26 | Track and trace system |
| 28 | Scanner |
| 30 | Data arrow |
| 32a, b | Material table |
| 34 | Data arrow |
| 36 | Online marketplace |
| 38 | Data arrow |
| 40 | Cloud-based server |
| 42 | Method |

1. A method for recycling residual material, the method comprising:
C) filling unmixed residual material into a container having a tracker of a track and trace system;
D) storing information about a type of material of the unmixed residual material in the tracker; and
E) transporting the container to a recycler of the unmixed residual material, wherein the method steps C) and D) are performable in any order or at the same time.

2. The method according to claim 1, the method further comprising:
B) prior to method step C), crushing the unmixed residual material using a crusher,
wherein in method step D, the storing of the information about the type of material of the unmixed residual material on the tracker is performed using the crusher.

3. The method according to claim 1, wherein the unmixed residual material comprises a skeleton remaining from a previous sheet-metal processing process.

4. The method according to claim 3, wherein the unmixed residual material comprising the skeleton is crushed by a crusher in the form of skeleton clippers.

5. The method according to claim 2, the method further comprising:
A) prior to the method step B), cutting sheet-metal parts out of a sheet-metal plate using a machine tool so as to produce a skeleton.

6. The method according to claim 5, wherein the information about the type of material is transmitted from the machine tool to the skeleton clippers, or
wherein the information about the type of material is applied to the skeleton in the form of a code at the machine tool and is read by a camera of the skeleton clippers.

7. The method according to claim 1, wherein the tracker comprises information about a material number, a producer, or a weight of the unmixed residual material.

8. The method according to claim 1, wherein the information stored on the tracker is uploaded at least partially to a cloud-based server.

9. The method according to claim 8, wherein the information stored on the tracker is displayed at least partially in an online marketplace.

10. A system for recycling residual material, the system comprising:
a) a container and a track and trace system, a tracker of the track and trace system being arranged or formed on the container, the tracker being configured to store information about a type of material of residual material stored in the container; and
b) a crusher configured to fill the container with unmixed residual material.

11. The system according to claim 10, the system further comprising a machine tool configured to feed the crusher.

12. The system according to claim 10, wherein the crusher is designed to store the information about the type of material on the tracker.

13. The system according to one claim 10, wherein a machine tool is connected to the crusher in a wireless and/or wired manner in order to transmit the information about the type of material from the machine tool to the crusher; and/or
wherein the crusher comprises a camera configured to scan a code on a skeleton and to read the information about the type of material therefrom.

14. The system according to claim 10, the system further comprising a cloud-based server configured to receive the information about the type of material from the tracker.

15. The system according to claim 14, the system further comprising an online marketplace configured to display the information about the type of material.
